(19) United States
(12) Patent Application Publication
(10) Pub. No.: US 2002/0108310 A1
(43) Pub. Date: Aug. 15, 2002

(54) Vehicle door for a convertible

(76) Inventor: Clemens Schroer, Marl (DE)

Correspondence Address: LINIAK. BERENATO, LONGACRE & WHITE, Suite 240, 6550 Rock Spring Drive, Bethesda, MD, 20817, US

(21) Appl. No.: 10/067,975

(22) Filed: Feb. 8, 2002

(30) Foreign Application Priority Data
Feb. 14, 2001 (DE) 101 07 121.3

(51) Int. Cl. E05F 15/00

(52) U.S. Cl. 49/280

(57) ABSTRACT

The invention relates to a vehicle door for a convertible having a door handle (2) with a handle part (5) which can be pivoted from its inoperative position into an actuating position in order to open the vehicle door (1), and having a window (13) which can be displaced by means of an electric window-opening motor (12) and when closed is sealed by a seal on the vehicle roof.

In order to achieve the effect, in a simple manner, that when the vehicle door (1) is opened, lowering of the window (13) from the seal on the vehicle roof takes place as early as possible, the invention proposes that the handle part (5) is operatively connected to an electric switch (9;9′) and the latter is connected via an electrical connection (10) to a control device (11), which controls the window-opening motor (12), in such a manner that when the handle part (5) is pulled, the switch (9;9′) activating the control device (11) is actuated, and the control device (11) generates a control voltage which activates the window-opening motor (12) until the window (13) is no longer situated within the seal on the vehicle roof.

The invention relates to a vehicle door for a convertible having a door handle with a handle part which can be pivoted from its inoperative position into an actuating position in order to open the vehicle door, and having a window which can be displaced by means of an electric window opener, according to the features of the precharacterizing clause of claim 1.

Since the side doors in the case of passenger vehicles having a folding top which can be folded back (convertibles) do not, as a rule, have an upper window pane frame, the sealing of the particular window pane against the ingress of any moisture etc. from the roof is undertaken by a seal arranged on the vehicle roof.

In order to avoid problems when opening and closing the side vehicle door, if the window pane is in its upper position, it has already been proposed to lower the particular window pane somewhat before the vehicle door is opened. For this purpose, a switch is arranged in the region of the rotating latch of the door lock. As soon as the door is opened and, as a result, the rotating latch is pivoted, the switch generates a pulse and activates an electric control device. The latter acts on the window-opening motor, which then lowers the window pane by a few centimeters.

In the case of this known vehicle door, it has proven disadvantageous that the lowering of the window pane and the opening of the vehicle door take place virtually at the same time, which can then lead to problems when opening the door, particularly if said door is opened very rapidly.

The invention is based on the object of specifying a vehicle door of the type mentioned at the beginning, in which the effect is achieved, in a simple manner, that during the opening process a lowering of the side window pane takes place earlier than is the case with the vehicle doors mentioned above.

According to the invention, this object is achieved by the features of claim 1. Further particularly advantageous refinements of the invention are disclosed by the subclaims.

The invention is essentially based on the concept that the activation of the switch, which activates the window-opening motor via the control device, is not undertaken by the rotating latch in the door lock, but by the handle part of the door handle, or by a part connected to the handle part.

The fastening of the switch and its actual activation by the handle part can take place in different ways and depends on the door handle used in each case and on the space conditions within the vehicle door.

When a door handle having a bearing bracket which can be fastened from the interior of the door is used, it has proven advantageous also to fasten the switch to the bearing bracket. In this arrangement, it has proven expedient, for space reasons, to arrange the switch on the outside of the bearing bracket. In the case of one embodiment of this type, it is advantageous for the handle part and the switch to be connected to each other via a pivotable lever arrangement having two axially spaced lever arms. In this case, the first lever arm is operatively connected to the handle part directly or via a further lever, and the second lever arm acts on the switch during the pivoting movement caused by the handle part. The rotating spindle connecting the two lever arms is guided pivotably through an opening in the corresponding side wall of the bearing bracket.

The handle part may be either a bracket-type handle or a flap-type handle. In addition, the activation of the window-opening motor for lowering the window pane from the seal on the vehicle roof can take place both by a switch arranged on the outside door handle and a switch arranged on the inside door handle.

The switches used can be electric switches or optical or magnetic switches.

The control device for activating the window-opening motor can be arranged both on the inside and on the outside of the vehicle door and can be part of a central control arrangement of the vehicle.

Further details and advantages of the invention emerge from the following exemplary embodiments which are explained with reference to figures, in which:

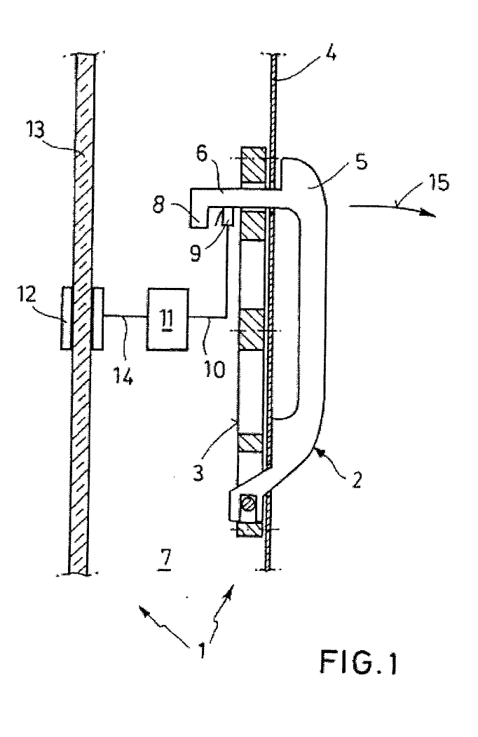

FIG. 1 shows a schematic illustration of the part of a vehicle door according to the invention having a door handle, a control device and a window opener;

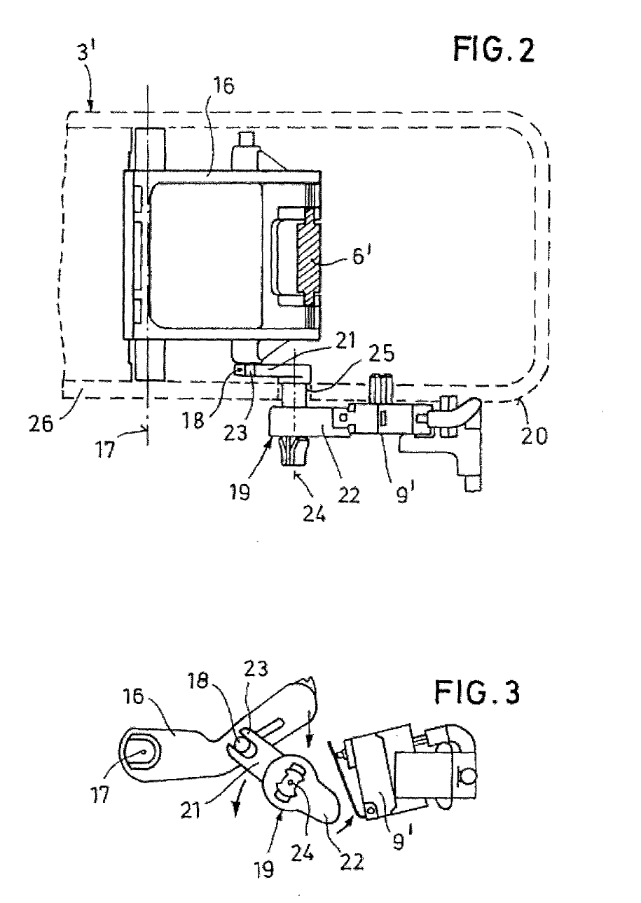

FIG. 2 shows the view of a bearing bracket (illustrated by dashed lines) for an outside door handle having a switch fastened thereto and a lever arrangement for transmitting the pivoting movement of the handle part to the switch, as seen from the inside of the door, and

FIG. 3 shows a side view of the lever arrangement illustrated in FIG. 2 with the bearing bracket omitted.

In FIG. 1, a vehicle door for a convertible is denoted by 1 and an outside door handle is denoted by 2. The door handle 2 comprises a bearing bracket 3, via which it is fastened to the outer skin 4 of the vehicle door 1, and a handle part 5, which is designed as a bracket-type handle.

The handle part 5 has, on its front end, a handle pin which reaches into the interior 7 of the vehicle door 1 and is provided with a projection 8, the function of which will also be described below.

Fastened to the bearing bracket 3 is a microswitch 9 which is connected via an electrical connection 10 to a control device 11 situated in the vehicle door 1.

The control device 11 is, for its part, connected via an electrical connection 14 to a window-opening motor 12 of a window opener (not illustrated in detail) for raising and lowering a side window pane 13. When the window pane 13 is closed, it is displaced into a seal, for example a U-shaped seal (not illustrated), on the corresponding vehicle roof.

If the vehicle door 1 is to be opened from the outside, the vehicle owner pulls the handle bracket outwards in the direction of the arrow 15. As a result, the projection 8 presses against the microswitch 9, which generates a corresponding switch signal. The latter is received by the control device 11 which for its part activates the window-opening motor 12 for a defined period of time in such a manner that the side window pane 13 is lowered from the closed position to a sufficient extent that the upper edge of the window pane 13 is situated below the seal of the vehicle roof. The vehicle door is then subsequently opened.

The invention is not, of course, restricted to the above-described exemplary embodiment. In particular, it will frequently not be possible for a projection fastened on the handle pin to act on a corresponding microswitch, since the handle pin acts, for example, also on a lock linkage or on a spring-loaded rotating bracket etc. As a rule, it will therefore be necessary to connect the handle part and the switch to each other via a pivotable lever arrangement. A corresponding exemplary embodiment is illustrated in FIGS. 2 and 3.

In this arrangement, the bearing bracket (which is indicated by dashed lines) is denoted by 3′. Situated within the bearing bracket 3′ is a rotating bracket 16, which is mounted in the bearing bracket 3′ in a manner such that it can pivot about a first rotating spindle 17. The handle pin 6′ of a bracket-type handle, which is situated behind the plane of the figure, engages on the rotating bracket 16. The rotating bracket 16 is acted upon by a torsion spring (not illustrated) and serves primarily to hold the bracket-type handle in its inoperative position, if it is not actuated. Of course, it may also, however, be used as a release lever for actuating a lock linkage or a Bowden cable.

A driver 18 is arranged on the rotating bracket 16, said driver acting, via a two-armed transmission lever 19 on a microswitch 9′ fastened to the outside 20 of the bearing bracket 3′. The two lever arms 21,22 of the transmission lever 19 are at an axial distance from each other, which distance is selected in such a manner that the first lever arm 21, which is connected rotatably to the driver 18 via a fork-shaped end 23, is situated within the bearing bracket 3′ and the second lever arm 22 is situated outside the bearing bracket 3′, in the region of the microswitch 9′. In this arrangement, the second rotating spindle 24 connecting the two lever arms is guided pivotably through an opening 25, which acts as a bearing bushing, in the side wall 26 of the bearing bracket 3′.

If the handle bracket is pulled outwards in order to open the vehicle door (i.e. to the opposite side of the image plane in FIG. 2 and downwards in FIG. 3), the rotating bracket 16 in FIG. 2 is pivoted downwards about the rotating spindle 17. The driver 18 then likewise pivots the first lever arm 21 downwards about the second rotating spindle 24, and the second lever arm 22 is pressed upwards against the microswitch 9′, with the result that the latter generates a corresponding switch signal. The switch signal is then transmitted in turn to a control device for actuating a window-opening motor.

### LIST OF REFERENCE NUMBERS

1 Vehicle door

2 Outside door handle, door handle

3,3′ Bearing bracket

4 Outer skin

5 Handle part, handle bracket

6,6′ Handle pin

7 Interior (of the vehicle door)

8 Projection

9,9′ Microswitch, switch

10 Electrical connection

11 Control device

12 Window-opening motor

13 Side window pane, window, window pane

14 Electrical connection

15 Arrow

16 Rotating bracket

17 First rotating spindle

18 Driver

19 Transmission lever

20 Outside

21 First lever arm

22 Second lever arm

23 Fork-shaped end

24 Second rotating spindle

25 Opening

26 Side wall

1. Vehicle door for a convertible having a door handle (2) with a handle part (5) which can be pivoted from its inoperative position into an actuating position in order to open the vehicle door (1), and having a window (13) which can be displaced by means of an electric window-opening motor (12) and when closed is sealed by a seal on the vehicle roof, characterized in that the handle part (5) is operatively connected to an electric switch (9;9′) and the latter is connected via an electrical connection (10) to a control device (11), which controls the window-opening motor (12), in such a manner that when the handle part (5) is pulled, the switch (9;9′) activating the control device (11) is actuated, and the control device (11) generates a control voltage which activates the window-opening motor (12) until the window (13) is no longer situated within the seal on the vehicle roof.

2. Vehicle door according to claim 1, characterized in that the door handle (2) for fastening to the vehicle door (1) comprises a bearing bracket (3;3′), and in that the switch (9;9′) is fastened to the bearing bracket (3;3′).

3. Vehicle door according to claim 2, characterized in that the handle part (5) and the switch (9′) are connected to each other via a pivotable lever arrangement (16,19).

4. Vehicle door according to claim 3, characterized in that the handle part (5) is connected to a spring-loaded rotating bracket (16) which can pivot about a first rotating spindle (17) and holds the handle part (5) in an inoperative position, and in that the rotating bracket (16) contains a driver (18), which is operatively connected to the first lever arm (21) of an at least two-armed transmission lever (19), which can pivot about a second rotating spindle (24), and the second lever arm (22) of which acts on the switch (9′) in such a manner that when the rotating bracket (16) is pivoted out of its inoperative position, the first lever arm (21), and therefore also the second lever arm (22), is pivoted via the driver (18) and the switch (9′) is actuated.

5. Vehicle door according to claim 4, characterized that the rotating bracket (16) is arranged within the bearing bracket (3′) and the switch (9′) is arranged on the outside of the bearing bracket (3′), and in that the two lever arms (21,22) of the transmission lever (19) are at an axial distance from each other, said distance being selected in such a manner that the first lever arm (21) is situated within the bearing bracket (3′) and the second lever arm (22) is situated outside the bearing bracket (3′), and the rotating spindle (24) connecting the two lever arms (21,22) is guided pivotably through an opening (25) in the corresponding side wall (26) of the bearing bracket (3′).
